(19) United States
(12) Patent Application Publication
(10) Pub. No.: US 2006/0234107 A1
(43) Pub. Date: Oct. 19, 2006

(54) Fuel cell plates and assemblies

(76) Inventors: David Earl Leger, Chilliwack (CA); Shane Carver Black, Chilliwack (CA); Andrew Gordon Holtby, Cultus Lake (CA)

Correspondence Address: COURSEY & COURSEY, P.C., 1930 NORTH DRUID HILLS ROAD, SUITE 150, ATLANTA, GA, 30319, US

(21) Appl. No.: 10/513,318

(22) PCT Filed: Jun. 3, 2002
(86) PCT No.: PCT/CA02/00816

§ 371 Date: Aug. 11, 2005

(30) Foreign Application Priority Data
May 3, 2002 (CA) 2,380,637

(51) Int. Cl. H01M 8/02; H01M 8/10

(52) U.S. Cl. 429/38; 429/30

(57) ABSTRACT

A fuel cell plate comprises a basic plate generally adaptable to be used, for a flow of a fluid, as a cathode. The basic plate has essentially a trapezoidal top view, delimitated by a pair of longitudinal margins, and a long and short transversal margins and is provided with inlet and outlet apertures, the former being disposed parallel and close to the long transversal margin, while the latter is disposed close to the short transversal margin. The basic plate also incorporates a continuous wall, spaced from the pair of longitudinal margins and the long and short transversal margins, and extending upwardly from a top of the basic plate, the continuous wall circumscribing a flow field divided into a multiplicity of channels. Cross-sections of the flow field of the basic plate, open to the flow of fluid entering through the inlet apertures, then flowing throughout the channels and exiting through the outlet apertures, continuously diminish, so that, accordingly, velocities of the fluid continuously increase.

### BACKGROUND OF THE INVENTION

1. Field of the Invention

The present invention relates generally to fuel cells, and in particular to fuel cell plates and assemblies.

2. Description of the Prior Art

Fuel cell have been developed as a power source for various uses and, without question, the field of fuel cells is very active and a need for continuous improvements is very actual. The advent of new materials, such as carbon and polygraphites, has resulted in a proliferation of new types and configurations of fuel cell plates and assemblies thereof.

Despite important improvements in present fuel cells, they still suffer from drawbacks, which are seemingly inherent in their structural concept.

Among the attempts that have been made in the past to address a number of fuel cell concerns, one can cite the following patents: U.S. Pat. No. 6,322,919 dated Nov. 27, 2001 and granted to Yang, et al. for a “Fuel cell and bipolar plate for use with the same”. This patent discloses a fuel cell bipolar plate including a fuel side having a series of fuel channels defining respective fuel paths and an oxidant side having a series of oxidant channels defining respective oxidant paths. At least some of the fuel channels are offset from adjacent channels in a direction transverse to the fuel and oxidant paths. A fuel manifold is connected to the fuel channels, while an oxidant manifold is connected to the oxidant channels. One of the two manifolds is located between the bipolar plate and the other manifold, where a connector extends from whichever manifold is outermost to the associated fuel or oxidant channels. In its configuration, Yang, et al. bipolar plate has two basic shortcomings. First, the bipolar plate is rectangular resulting in a pressure drop along flow channels. Second, as a result of pressure drop, larger ancillary devices are required, thus, leading to lower overall fuel cell stack power output. U.S. Pat. No. 6,358,642 dated Mar. 19, 2002 and granted to Griffith, et al. for a “Fuel channels for fuel cell”. This patent describes serpentine flow channels whose length can be varied. The flow field comprises a plurality of lands that engage the current collector and define a plurality of substantially equal-length serpentine gas flow channels. Each of the latter has an inlet leg for receiving gas from a supply manifold that is common to all of the flow channels; an exit leg for discharging the gas into an exhaust manifold that is common to all of the flow channels; and at least one medial leg that lies intermediate the inlet and exit legs. The inlet, exit and medial legs for each channel border at least one other leg of the same channel. This patent has two basic disadvantages. First, it is physically understood that a serpentine channel design will cause significant pressure drop, from inlet to exit openings. Second, the serpentine channels used as a cathode can result in an accumulation of moisture droplets within, which requires, for clearing, an increased pressure.

There are many other patents relating also to various types of fuel cell plates and assemblies. For example: U.S. Pat. Nos. 6,350,540; 6,348,280; and 6,329,093.

The inventors believe that the identified patents taken alone or in combination neither anticipate nor render obvious the present invention. The foregoing citation relate only to the general field of the invention and are cited as constituting the closest art of which the inventors are aware.

### SUMMARY OF THE INVENTION

After substantial experimentation, the inventors have discovered that by changing the shape of the cell plates the efficiency and the versatility of the latter could be significantly enhanced.

Thus, it is the primary objective of this invention to provide a cell plate with increased velocities of fluid flow during the passage along the channels.

It is another objective of this invention to provide compact cell plates to enhance the versatility of applications.

It yet another objective of this invention to develop a fuel cell plate, whose configuration allows the use of fuel cell stacks, in circularly disposed assemblies. Broadly stating, a fuel cell plate, according to the present invention, comprises a basic plate generally adaptable to be used for a flow of a fluid, as a cathode and having essentially a trapezoidal top view delimitated by a pair of longitudinal margins, and a long and short transversal margins. The basic plate is also provided with inlet and outlet apertures, the former being disposed parallel and close to the long transversal margin, while the latter is disposed close to the short transversal margin. A continuous wall is spaced from the pair of longitudinal margins and the long and short transversal margins and extends upwardly from a top of the basic plate. The continuous wall circumscribes a flow field divided into a multiplicity of channels, whereby cross-sections of the flow field of the basic plate, open to the flow of fluid entering through the inlet apertures, then flowing throughout the channels and exiting through the outlet apertures, continuously diminish, so that, accordingly, velocities of said fluid continuously increase.

In one aspect of the present invention, a fuel cell plate comprises a basic plate generally adaptable to be used for a flow of a fluid, as a cathode. The basic plate has essentially a trapezoidal top view delimitated by a pair of longitudinal margins, and a long and short transversal margins. The basic plate is also provided with inlet and outlet apertures, the former being disposed parallel and close to the long transversal margin, while the latter is disposed parallel and close to the short transversal margin. A continuous wall is spaced from the pair of longitudinal margins and the long and short transversal margins and extends upwardly from a top of the basic plate. The continuous wall circumscribes a flow field divided in three flow field compartments: two side flow field compartments and one central flow field compartment. Each of the side flow field compartment is defined by a first portion of the continuous wall, close to the longitudinal margin, by a second portion of the continuous wall, close to the long transversal margin, by a third portion of the continuous wall, close to the short transversal margin and finally by an internal wall, the later extending between the second and third portions, respectively. The central flow field compartment is defined by the second portion of the continuous wall, by the third portion of the continuous wall and by two oppositely disposed internal walls. In the interior of each side and central flow field compartments, proximate and parallel to the long transversal margin, four equally spaced inlet apertures extend through the basic plate. In the interior of each side and central flow field compartments, proximate to the short transversal margin, an outlet aperture extending through said basic plate is provided, the interior of each of said side flow field compartment being divided into an external and internal sub-compartments. The external sub-compartment is defined by the first portion of the continuous wall and by a central longitudinal rib. The internal sub-compartment is defined by an internal wall and by the central longitudinal rib. External and internal sub-compartments are equally divided into two elementary compartments by a separating rib that starts from the second portion and ends short of the outlet aperture. Each elementary compartment is equally divided into two unitary compartments by a partition rib that extends short of the inlet and outlet apertures. Short partition ribs, equally spaced on either side of the partition rib, extend from a point near the inlet aperture to a point close to the midway between the long and short transversal margins. Tops of the continuous wall, the internal wall, the central longitudinal ribs, the separating rib, the partition ribs and the short partition ribs are coplanar. Channels are formed between the first portions of the continuous wall, the internal, the central longitudinal ribs, the separating rib, the partition ribs and the short partition ribs.

In another aspect of this invention, basic plate is bipolar incorporating a bottom provided with several recessed passages sinuously extending, parallel to each other and to the long and short transversal margins, between an inlet and outlet openings. A length of transversal segments of the recessed passages continuously diminishes. In another aspect of this invention, a basic plate incorporating a flat bottom is unipolar.

In yet another aspect of this invention, a fuel cell basic unit comprises a pair of fuel cell plates, using basic plates of bipolar type, between which an ion exchange membrane is disposed.

In a last aspect of this invention, a fuel cell stack comprises several superimposed fuel basic units. A collector plate is disposed on a top and under a bottom of the superimposed fuel basic units. A sealing plate is positioned on a top of the collector plate, while a manifold plate is placed beneath the collector plate.

### BRIEF DESCRIPTION OF THE DRAWINGS

Although the characteristic features of this invention will be particularly pointed out in the claims, the invention itself and the manner in which it may be made and used, may be better understood in the following description taken into connection with the accompanying drawings, wherein like reference numerals refer to like parts throughout the several views, in which

FIG. 1 depicts a perspective top view of a fuel cell plate according to the present invention;

FIG. 2 depicts a perspective bottom view of the fuel cell plate of FIG. 1; and

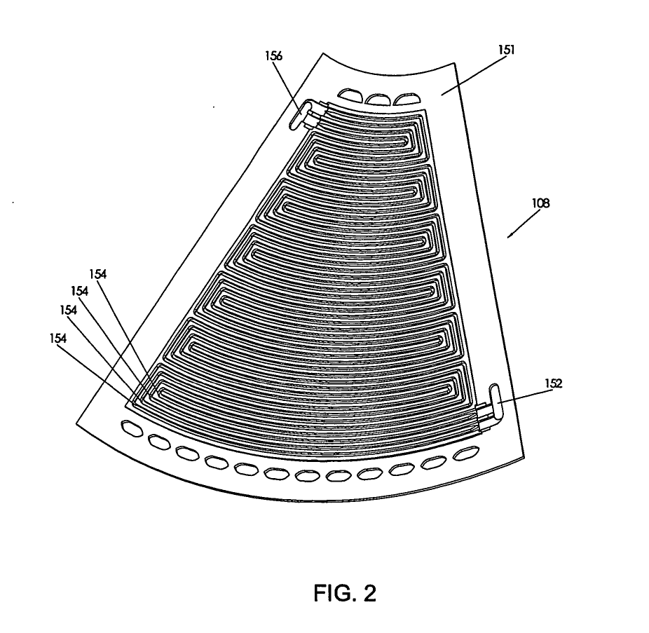

FIG. 3 depicts a perspective view of a fuel cell stack including a fuel cell basic unit.

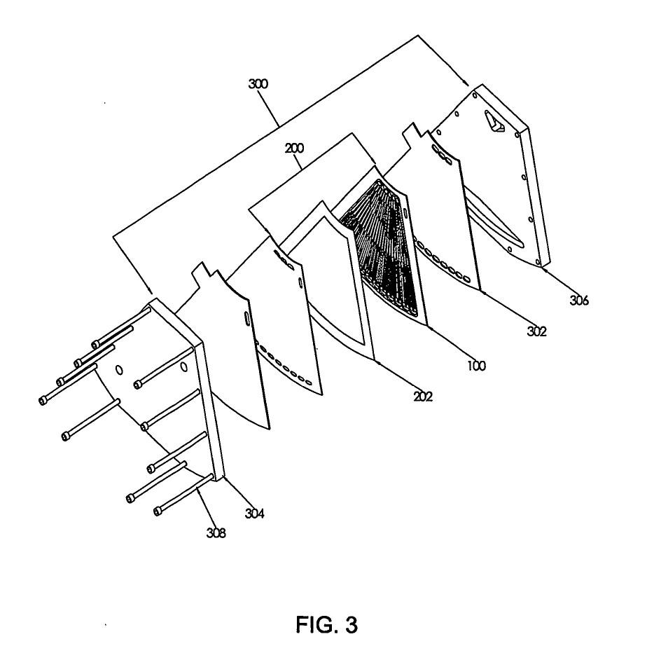

### DESCRIPTION OF THE PREFERRED EMBODIMENTS

It is to be agreed, that terms such as “top”, “bottom” and “upwardly” are conventionally used in the present description with reference to the normal position in which fuel cell plates and assemblies would be normally used.

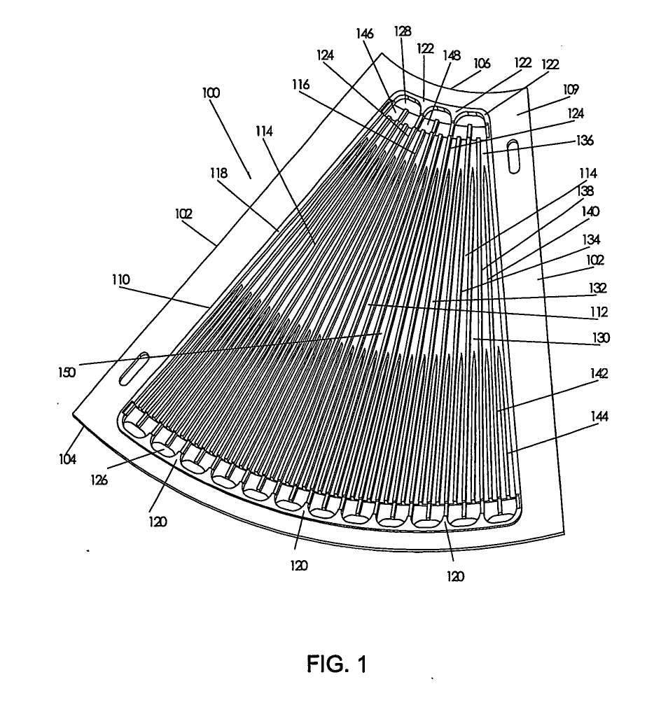

Referring in detail to FIGS. 1 through X, a fuel cell plate 100 has a trapezoidal top view, delimitated by a pair of longitudinal margins 102, a long transversal margin 104 and a short transversal margin 106. The former and the latter are curvilinear. Alternatively, long and short transversal margins 104 and 106 can be rectilinear. Fuel cell plate 100 comprises a basic plate 108 having a top 109, preferably serving as a cathode, from which a continuous wall 110, spaced from longitudinal margins 102 and long and short transversal margins 104 and 106, extends upwardly.

Continuous wall 110 circumscribes a flow field 112, which is divided in three flow field compartments: two side flow field compartments 114 and one central flow field compartment 116. Each side flow field compartment 114 is defined by a first portion 118 of continuous wall 110, close to longitudinal margin 102, by a second portion 120 of continuous wall 110, close to long transversal margin 104, by a third portion 122 of continuous wall 110 close to short transversal margin 106 and finally by an internal wall 124. The later extends between second and third portions 120 and 122, respectively. Central flow field compartment 116 is defined by second portion 120 of continuous wall 110, by third portion 122 of continuous wall 110 and by two oppositely disposed internal walls 124.

Obviously, each resulted side flow field compartments 114 and central flow field compartment 116 has a trapezoidal top view.

In the interior of each side and central flow field compartments 114 and 116, proximate and parallel to long transversal margin 104, there are four equally spaced inlet apertures 126, which extend through basic plate 108.

In the interior of each side and central flow field compartments 114 and 116, proximate to short transversal margin 106 there is one outlet aperture 128, which extends through basic plate 108.

The interior of each side flow field compartment 114 is divided into an external and internal sub-compartments 130 and 132, respectively. An external sub-compartment 130 is defined by first portion 118 of continuous wall 110 and by a central longitudinal rib 134, while an internal sub-compartment 132 is defined by an internal wall 124 and by a central longitudinal rib 134.

The external and internal sub-compartments 130 and 132 are equally divided into two elementary compartments l36 by a separating rib 138 that starts from second portion 120 and ends short of outlet aperture 128. Each elementary compartment 136 is equally divided in to two unitary compartments 140 by a partition rib 142 that extends short of inlet and outlet apertures 126 and 128, respectively.

Short partition ribs 144, equally spaced on either side of partition rib 142, extend from a point near inlet aperture 126 to a point close to the midway between long and short transversal margins 104 and 106.

The tops of continuous wall 110, internal wall 124, central longitudinal ribs 134, separating rib 138, partition ribs 142 and short partition ribs 144 are coplanar. For technological reasons, inlet and outlet apertures 126 and 128, as well as adjacent zones 146 extending from the former and the latter towards the center of flow field plate 100 are incorporated into an element 148 inserted into flow field plate 100.

As a corollary of the above description, wherein each of the following:
basic plate 108;
flow field 112 circumscribed by continuous wall 110 and divided in
side flow field compartments 114 and
central flow field compartment 116, the former and the latter being subdivided in
external and internal sub-compartments 130 and 132, which are further subdivided in
elementary compartments 136 finally subdivided in
unitary compartments 140

has a trapezoidal top view; and due the fact that
channels 150 are formed between continuous wall 110, internal wall 124, central longitudinal ribs 134, separating rib 138, partition ribs 142 and short partition ribs 144; and due to the fact that
in the interior of each side and central flow field compartments 114 and 116, proximate to long transversal margin 104, there are four equally spaced inlet apertures 126, which extend through basic plate 108 and
in the interior of each side and central flow field compartments 114 and 116, proximate to short transversal margin 106 there is one outlet aperture 128, which extends through basic plate 108,

cross-sections of flow field 112 of basic plate 108, open to a flow of fluid entering through inlet apertures 126, then flowing throughout channels 150 and exiting through outlet apertures 128, continuously diminish so that, accordingly, velocities of said fluid continuously increase.

Alternatively, flow field plate 100 having top 109, as described above, can be used as an anode.

In one variant of the above embodiment, basic plate 108 is bipolar, having a bottom 150 serving as an anode.

An inlet opening 152 penetrates throughout basic plate 108 and communicates with four recessed passages 154 sinuously extending, parallel to each other and to long and short transversal margins 104 and 106, towards an outlet opening 156.

Obviously, due to the shape of basic plate 108, which has a trapezoidal top view, the length of transversal segments 158 of recessed passages 154 continuously diminishes. In another variant (not shown) of the above embodiment, use is made of a unipolar basic plate, having a flat bottom. This variant implies the use of a separate plate as an anode.

In another embodiment, illustrated in FIG. X, a fuel cell basic unit 200 comprises a pair of fuel cell plates 100, using basic plates 108 of bipolar type, between which an ion exchange membrane 202 is disposed.

In a last embodiment, illustrated in FIG. X, a fuel cell stack 300 comprises several superimposed fuel cell basic units 200, on a top and under a bottom of the latter, a collector plate 302 is disposed. A sealing plate 304 is positioned on a top of collector plate 302. A manifold plate 306 is placed beneath collector plate 302.

Fastening elements 308, attaching sealing plate 304 to manifold plate 306, maintain fuel cell stack 300 in an assembled form.

As required, detailed embodiments of the present invention are disclosed herein; however, it is to be understood that the disclosed embodiments are merely exemplary of the invention, which may be embodied in various forms. Therefore, specific structural and functional details disclosed therein are not to be interpreted as limiting, but merely as a basis for the claims and as a representative basis for teaching one skilled in the art to variously employ the present invention in virtually any appropriately detailed structure.

1-6. (canceled)

7. A fuel cell plate, comprising:
(a) a plate having a pair of major surfaces; and,
(b) a first flow field on one surface of the plate for flow of a first fluid therethrough, comprising a plurality of channels extending from an inlet end of the first flow field to an outlet end of the first flow field, wherein at least one channel has a cross-section that continuously diminishes in size along the channel between the inlet end and the outlet end, and wherein the channels are arranged on the plate surface such that the first flow field has a substantially trapezoidal configuration with the inlet end being wider than the outlet end.

8. A fuel cell plate as claimed in claim 7, wherein the width of at least one channel narrows along the channel between the inlet end and the outlet end.

9. A fuel cell plate as claimed in claim 8 wherein the channels are laterally separated by ribs having a substantially constant width.

10. A fuel cell plate as claimed in claim 9 wherein the plate has a substantially trapezoidal plan view conforming to the first flow field configuration.

11. A fuel cell plate as claimed in claim 7 further comprising an inlet aperture extending through the plate and in fluid communication with at least one channel at the inlet end of the channel, and an outlet aperture extending through the plate and in fluid communication with at least one channel at the outlet end of the channel.

12. A fuel cell plate as claimed in claim 7, wherein the first flow field comprises a cathode and the first fluid comprises air.

13. A fuel cell plate as claimed in claim 7 further comprising a second flow field on the surface of the plate opposite the first flow field and for the flow of a second fluid therethrough, the second flow field comprising a channel sinusoidally extending from an inlet end of the second flow field to an outlet end of the second flow field, wherein the channel is arranged on the plate surface such that the second flow field has a substantially trapezoidal configuration.

14. A fuel cell plate as claimed in claim 13, wherein the second flow field comprises an anode and the second fluid comprises gaseous fuel.

15. A fuel cell basic unit, comprising:
(a) a first fuel cell plate; and,
(b) a second fuel cell plate, wherein the first and second fuel cell plates sandwich an ion exchange membrane therebetween;
wherein the first fuel cell plate comprises:
a plate having a pair of major surfaces; and,
a first flow field on a surface of the first fuel cell plate facing the ion exchange membrane for flow of a first fluid therethrough, comprising a plurality of channels extending from an inlet end of the first flow field to an outlet end of the first flow field, wherein at least one channel has a cross-section that continuously diminishes in size along the channel between the inlet end and the outlet end, and wherein the channels are arranged on the plate surface such that the first flow field has a substantially trapezoidal configuration with the inlet end being wider than the outlet end;
wherein the second fuel cell plate comprises:
a plate having a pair of major surfaces; and,
a second flow field on a surface of the second fuel cell plate facing the ion exchange membrane for the flow of a second fluid therethrough, comprising a channel sinusoidally extending from an inlet end of the second flow field to an outlet end of the second flow field, wherein the channel is arranged on the plate surface such that the second flow field has a substantially trapezoidal configuration; and,
wherein portions of the ion exchange membrane contacting the first flow field of the first fuel cell plate define a reaction active area that continuously diminishes in size along the first flow field between the inlet end and the outlet end.
